(19) United States
(12) Patent Application Publication
(10) Pub. No.: US 2011/0209946 A1
(43) Pub. Date: Sep. 1, 2011

(54) STEP STOOL

(75) Inventor: Luhao Leng, Xiamen (CN)

(73) Assignee: NEW-TEC INTEGRATION(XIAMEN) CO., LTD., Fujian (CN)

(21) Appl. No.: 13/127,074

(22) PCT Filed: Nov. 5, 2009
(86) PCT No.: PCT/CN09/74815

§ 371 Date: May 2, 2011

(30) Foreign Application Priority Data
Nov. 6, 2008 (CN) 200820146256.3
Nov. 6, 2008 (CN) 200820146257.8
Nov. 6, 2008 (CN) 200820146258.2

(51) Int. Cl. A47C 12/00; E06C 7/50; E06C 5/36

(52) U.S. Cl. 182/129; 182/165

(57) ABSTRACT

A step tool has front and rear leg tubes, a bottom and top footplate, a connection device for connecting the footplate and the leg tubes, a lock catch device of the top footplate. The front leg tubes are joined to the rear leg tubes rotatably. The foreside of the top footplate joins to the front leg tubes rotatably. A rail is fixed on the rear leg tubes. The lock catch is disposed on the top footplate and is detachedly connected to the rail. The lock catch device includes two connecting ears, a rotation axis, a lock catch and a torsion spring.

### FIELD OF THE INVENTION

The invention relates to a step tool using on high.

### BACKGROUND OF THE INVENTION

The existing step tool includes front leg tubes, the rear leg tubes, the top footplate and the lock catch device, the front leg tubes joint to the rear leg tube rotatably, the top footplate joint to the front leg tubes rotatably, a rail is disposed on the leg tubes. The lock catch device is disposed in the top footplate and joints to the rail, the leg tubes and a footplate disposed between the two leg tubes assembly and disassembly. As a special step tool for user to work on high, it requires high fixation effect of the top footplate of the step tool. The name of the letter patent is “a lock catch structure of the step tool” published in the Chinese patent data in Apr. 18, 2007. The notification number is CN2889017Y. A lock catch structure of the step tool includes a hook pivot to a first hinge plate, the hook rotates around the pivot point, the hook is disposed with a channel for the entry of the tongue fixed in the second hinge plate; a spring is fixed in the hook; a lock hook joints to the hook rotatably by a pivot element; one end of the lock hook joints to the free end of the spring fixed in the hook; the lock hook is disposed with a hook groove holding the tongue of the second hinge plate.

The release steps of the lock catch includes:

1. Rotate the lock hook, making the lock hook far away from the tongue;
2. continue rotate the hook, making the hook far away from the tongue;
3. then rotate the first hinge plate and the second hinge plate relatively, making the front leg tubes and the rear leg tubes folding together.

As we know from the above, the release steps includes several steps with complicated release and inconvenient usage.

### SUMMARY OF THE INVENTION

The object of the present invention is to provide a step tool, which overcomes the disadvantage of the existing step tool that the lock catch device is complicated to release and difficult to use.

Another object of the present invention is to provide lock catch device for connecting the footplate and the leg tubes in a step tool.

Another object of the present invention is to provide antiskid structure of a step tool.

The technical proposal of the present invention to resolve the problem of the existing technology is:

A step tool, includes front leg tubes, rear leg tubes, bottom footplate, top footplate, a connecting device for connecting the footplates and the leg tubes, lock catch device of the top footplate, the front leg tubes joint to the rear leg tubes rotatably, the foreside of the top footplate joints to the front leg tubes rotatably, a rail is fixed on the rear leg tubes, the lock catch device disposed on the top footplate is detachedly connecting to the rail, wherein:
The lock catch device includes: Two connecting ears, which are disposed on the top footplate with space between in the right and left and stick out of the bottom side of the top footplate;
A rotation axis, which passes through the two connecting ears rotatably;
A lock catch fixed to the rotation axis is disposed with hook rabbet to hook the rail from the outsides towards the inner; and
A torsion spring, which interlinks the rotation axis and generates torque to rotate the rotation axis, the both ends of the torsion spring support against the footplate and the lock catch separately.

The top footplate includes a supporting frame to rest on the rail and a panel disposed on the supporting frame; the connecting ears are disposed on the panel and stick out of the bottom surface of the panel; the supporting frame encircles the rotation axis, torsion spring and the lock catch.

A stop is disposed on the bottom side of the panel to limit the maximum turned angel of the lock catch, the stop is located between the two connecting ears; the distance between the upper end of the lock catch and the axes of the rotation axis is greater than the distance between the end of the stop and the axes of the rotation axis.

Two through holes are disposed on the panel with space between in the right and left and pass through from the up to down; an intermediate plate is disposed to fix the two connecting ears, which pass through the through holes from up to down and stick out of the bottom side of the panel, the intermediate plate rests on the top surface of the panel.

The lock catch is disposed with a substrate, two convex lugs are disposed on the substrate with space between in the right and left to connect the rotation axis; the top of the convex lug is disposed with a lug to lie against the stop.

A plane forms between the two lugs, one end of the torsion spring heads on the bottom side of the panel, the other end heads on the plane.

The lock catch is disposed with a substrate, a handle is disposed under the substrate, the handle sticks out to the inner side of the substrate, a hook rabbet is formed between the handle and the substrate, the surface of the handle is disposed with hand held groove.

Another technology of the present invention is: A step tool, includes front leg tubes, rear leg tubes, bottom footplate, top footplate, a connecting device for connecting the footplates and the leg tubes, lock catch device of the top footplate, the front leg tubes joint to the rear leg tubes rotatably, the foreside of the top footplate joints to the front leg tubes rotatably, a rail is fixed on the rear leg tubes, the lock catch device disposed on the top footplate is detachedly connecting to the rail, wherein:

The lock catch device includes: Two connecting ears, which are disposed on the top footplate with space between in the right and left and stick out of the bottom side of the top footplate;
A rotation axis, which passes through the two connecting ears rotatably;
A lock catch fixed to the rotation axis is disposed with hook rabbet to hook the rail from the outsides towards the inner; and
A torsion spring, which interlinks the rotation axis and generates torque to rotate the rotation axis, the both ends of the torsion spring support against the footplate and the lock catch separately.

The connecting device between the footplate and the leg tubes includes:

A plastic element, with a first location slot and a second location slot on the both right ant left side, the first location slot fits the leg tubes and touches the inner side of the leg tubes, the second location slot fits the end side of the footplate and touches the end side of the footplate; and
Lock pin, which passes through the leg tube and the plastic element and locks to the footplate.

Another technology of the present invention is: A step tool, includes front leg tubes, rear leg tubes, bottom footplate, top footplate, a connecting device for connecting the footplates and the leg tubes, lock catch device of the top footplate, the front leg tubes joint to the rear leg tubes rotatably, the foreside of the top footplate joints to the front leg tubes rotatably, a rail is fixed on the rear leg tubes, the lock catch device disposed on the top footplate is detachedly connecting to the rail, wherein:

The lock catch device includes: Two connecting ears, which are disposed on the top footplate with space between in the right and left and stick out of the bottom side of the top footplate;
A rotation axis, which passes through the two connecting ears rotatably;
A lock catch fixed to the rotation axis is disposed with hook rabbet to hook the rail from the outsides towards the inner; and
A torsion spring, which interlinks the rotation axis and generates torque to rotate the rotation axis, the both ends of the torsion spring support against the footplate and the lock catch separately.

The footplate is antiskid footplate, the antiskid footplate includes a substrate, which is disposed with a panel, the top surface of the substrate is disposed with several location slots, the bottom side of the location slots is disposed with at least a hole running through the top of the panel, every location slot is disposed with an antiskid strip, the bottom of the antiskid strip is disposed with at least an undercut, the undercut and the hole are fastening to each other corresponding.

Compared to the existing technology, the present invention has the advantages below:

The lock catch device, the connecting device and the footplate have been improved in a creative way, so that the step tool is used convenience with high reliability. With the hook groove of the lock catch hooking the rail in the present invention, the user can release the lock, turn the footplate and fold the step tool by catch the lock catch and lift it up. As the step tool is disposed with torsion spring, it can automatically lock up with high security. The lock catch device is disposed under the panel, so that it occupies little space, and retains the top footplate of holistic and handsome appearance. Both ends of the torsion spring withstand the plane and the panel separately; the lock catch gets clockwise torque, which ensures the substance of the lock catch and the high security. The handle is disposed with hand held groove, so that it is comfort for hand to release. A plastic element is disposed between the leg tubes and the footplate in the present invention, the first location slot fits the leg tubes and connects to the inner side of the leg tubes, the second location slot fits the leg tubes and connects to the end side of the footplate, which overcomes the said disadvantages of the existing step tool. The present invention has the advantages below:
1. preventing the footplate rotates relative to the lock pin and the leg tubes, which improves the security and the working life of the step tool;
2. the location slot of the plastic element encases the end side of the footplate and the leg tubes, which posses the wholeness of the step tool and the beautiful appearance;
3. enhancing the connecting strength between the footplate and the leg tubes;
4. Preventing the end surface of the footplate scratching the user. As the two lock pins are disposed with space between from up to down, it prevents the footplate rotates, with the high connecting strength between the leg tubes and the footplate. The footplate includes the supporting frame, which have the effects of connecting the component outsides, which is convenient for connecting. The lock pin is a rivet, which is convenient for assemble. The plastic element is cone shaped with the bigger end side touches the footplate and the smaller end side touches the leg tubes, which is convenient for the footplate rotation with reduced friction. At the same time, with the plastic element disposed between the leg tubes and the footplate, the footplate can be designed to new antiskid structure, which makes the step tool easily for use and high reliability.

### BRIEF DESCRIPTION OF THE DRAWINGS

FIG. 1 illustrates one of the schematic diagrams of the step tool in the first embodiment;

FIG. 2 illustrates another schematic diagram of the step tool in the first embodiment;

FIG. 3 illustrates the schematic diagram of the lock catch device in the first embodiment;

FIG. 4 illustrates the section diagram of the first step of locking the lock catch device in the first embodiment;

FIG. 5 illustrates the section diagram of the second step of locking the lock catch device in the first embodiment;

FIG. 6 illustrates the section diagram of the third step of locking the lock catch device in the first embodiment;

FIG. 7 illustrates the section diagram of the forth step of locking the lock catch device in the first embodiment;

FIG. 8 illustrates the section diagram of the lock catch device of locking status in the first embodiment;

FIG. 9 illustrates the decomposition diagram of the step tool in the first embodiment;

FIG. 10 illustrates the top view of FIG. 9;

FIG. 11 illustrates the enlargement diagram of the A part of FIG. 9;

FIG. 12 illustrates the enlargement diagram of the B part of FIG. 9;

FIG. 13 illustrates the schematic diagram of the top footplate in the second embodiment;

FIG. 14 illustrates the schematic diagram of the antiskid strip in the second embodiment;

FIG. 15 illustrates the top view of the top footplate in the second embodiment;

FIG. 16 illustrates the C-C section diagram of FIG. 15.

### DETAILED DESCRIPTION OF THE EMBODIMENTS

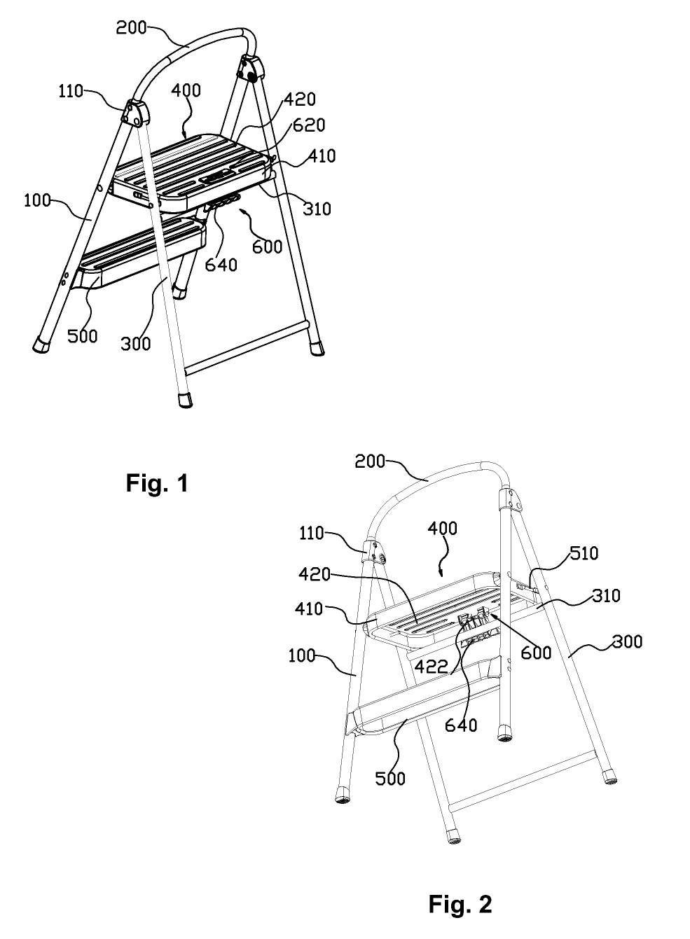

Refer to the FIG. 1 and the FIG. 2, the step tool includes two front leg tubes 100, a U-shaped tube 200, two rear leg tubes 300, a top footplate 400, a bottom footplate 500 disposed between the two front leg tubes 100 and a lock catch device 600.

The end of the U-shaped tube 200 fixes to the top of the front leg tubes by a pivot 110, the top of the rear leg tubes 300 rotating joints to the pivot 110, so that the front leg tubes 100 rotation connects to the rear leg tubes. A rail 310 is disposed between the two rear leg tubes 300.

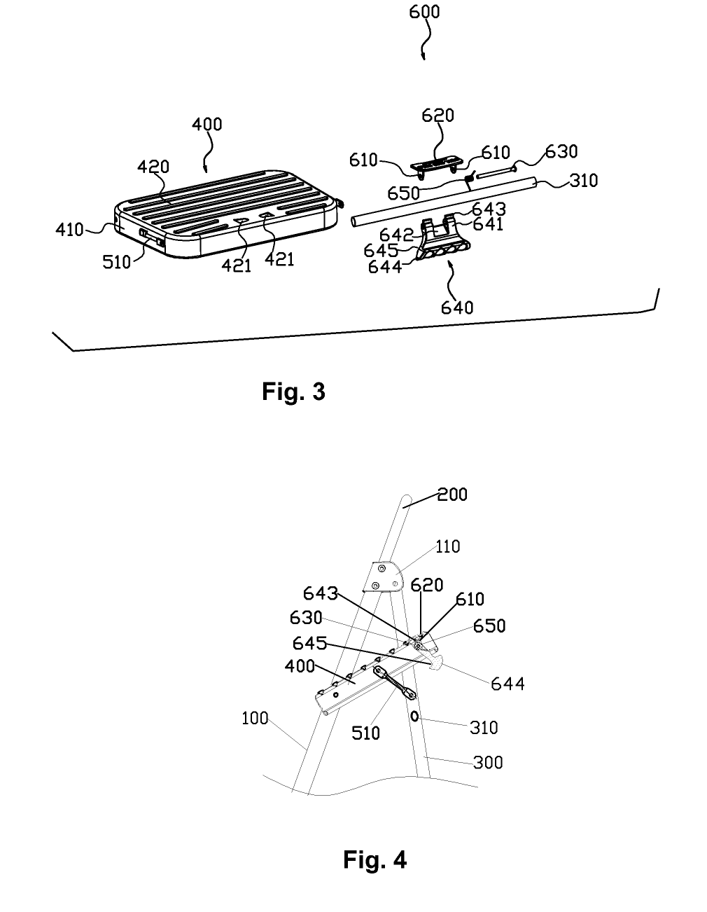

Refer to the FIG. 1, FIG. 2 and FIG. 3, the top footplate 400 is stamped integrally by steel piece or thin aluminum plate (or injection molded by injection plastic in one step molding), it includes a rectangle supporting frame 410 and a panel 420 fixed on the supporting frame 410. The foreside of the supporting frame 410 pivot joints to the two front leg tubes 100. A pivot piece 510 is disposed in the top footplate 400. The foreside of the pivot piece 510 pivot joints to the central of the supporting frame 410, and the backend of the pivot piece 510 pivot joints to the rear leg tubes 300. This connecting structure is existing technology, the further description is omitted to save space. There are two holes 421 disposed on the panel 420 with spaces between in the left and the right running through the up and down. The bottom side of the panel 420 is disposed with a stop 422 between the two holes 421 (two connecting ears 610).

The lock catch device 600 is disposed in the top footplate 400 and joints to the rail 310 assembly and disassembly. It includes two connecting ears 610, an intermediate plate 620, a rotation axis 630, a lock catch 640 and a torsion spring 650.

The intermediate plate 620 is fixed to the two connecting ears 610, which make the connecting ears 610 with space between in the left and right. The connecting ears 610 run through the holes 421 from up to down and stretch out of the bottom side of the panel 420. The intermediate plate 620 rests against the top side of the panel 420, which makes the intermediate plate 620, two connecting ears 610 and the panel 420 fixed to each other.

The rotation axis 630 passes through the two connecting ears rotatably.

The lock catch is disposed with a substrate. Two lugs 641 with space between and an inclined plane 642 disposed between the two lugs 641. The top of the lugs 641 is disposed with an embossed piece 643 projecting out. The two lugs 641 are fixed to the rotation axis 630, making the lock catch 640 rotates with the rotation axis 630. The distance between the end of the embossed piece 643 and the axis of the rotation axis 630 is greater than the distance between the stop 622 and the axis of the rotation axis 630. So that the stop 422 limits the maximum rotation angle of the lock catch 640, preventing the lock catch 640 from excessive rotation and the torsion spring 650 from excessive deformation, shortening the life of the torsion spring 650. A handle 644 is disposed under the substrate. The handle 644 stretches out of the inner side of the substrate, so that a hook rabbet 645 is formed between the handle 644 and the inner side of the substrate. The surface of the handle 644 is disposed with hand held groove.

The rotation axis 630 interlinks the torsion spring 650, which has two rest ends. The first rest end withstands the bottom side of the panel 420, and the second rest end withstands the rest surface 642 of the lock catch 640, making the lock catch 640 received the torque in a clockwise direction.

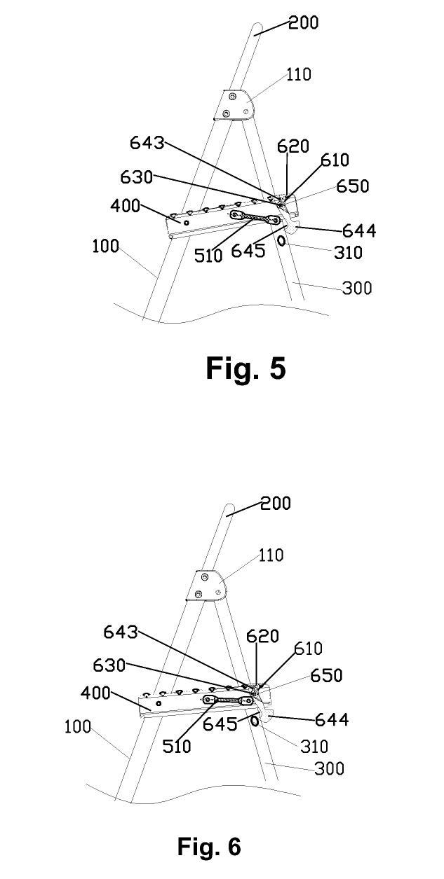

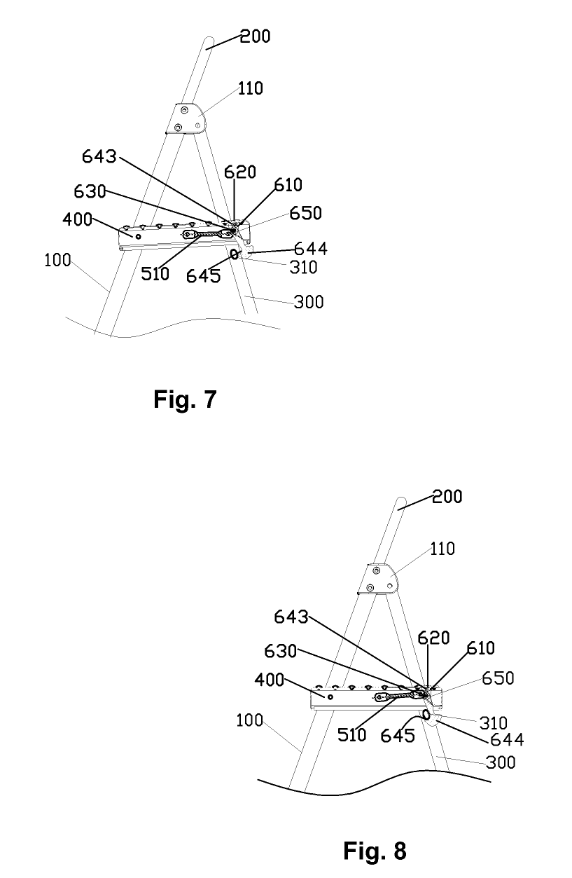

Refer to the FIG. 4, FIG. 5, FIG. 6, FIG. 7 and FIG. 8, which illustrates the lock catch sequence of the lock catch, the locking catch step includes:
1. unfolding the front leg tubes 100 and the rear leg tubes 300, the top footplate turns clockwise, as the FIG. 4 and the FIG. 5;
2. carrying on unfolding the front leg tubes 100 and the rear leg tubes 300, or turning the top footplate clockwise until the inner part of the handle 644 of the clock catch 640 touches the rail 310, as the FIG. 6 and the FIG. 7;
3. carrying on unfolding the front leg tubes 100 and the rear leg tubes 300, or turning the top footplate clockwise; the inner part of the hook rabbet 645 touches the rail 310 and slips down the rail 310 (getting over the deformation spring force); when slipping to a certain position, the lock catch turns clockwise in the torque of the torsion spring, the hook rabbet 645 hooks the rail 310 from outside to inside, the supporting frame 410 supports the rail 310 at this time, and the lock catch device 600 is in the status of lock, as the FIG. 8.

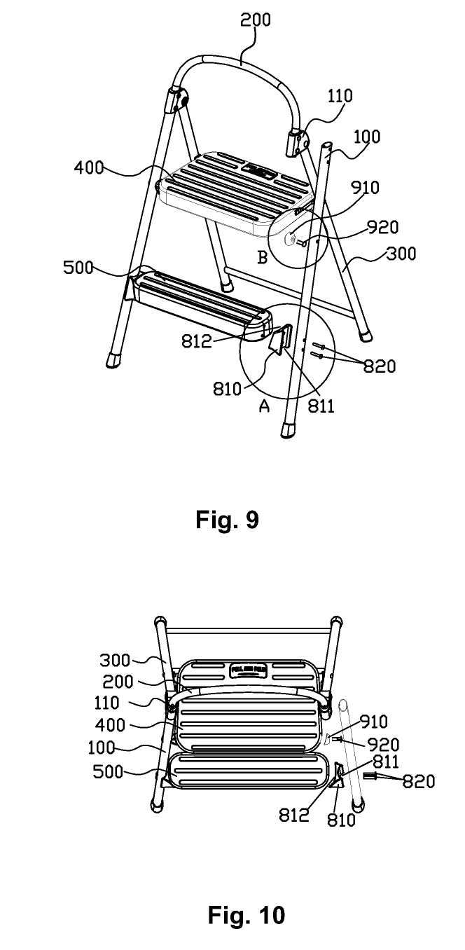

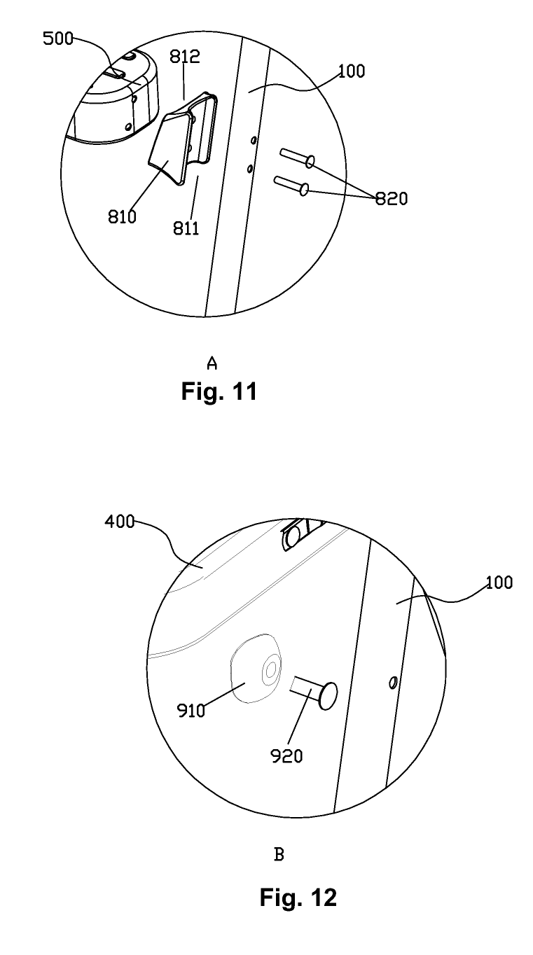

The connecting device to connect the footplate and the leg tubes in the FIG. 9, FIG. 10, FIG. 11, FIG. 12 is: the bottom footplate 500 is fixed between the two front leg tubes 100. The connecting device to connect the top footplate 500 and the front leg tubes 100 includes a first plastic element 810 and two first lock pin 820. The right and the left side of the first plastic element 810 are disposed with the first location slot 811 and the second location slot 812 separately. The first position 811 fits the front leg tubes 100, the inclined plane of the first location slot 811 fits the semi ellipse of the inner side of the front leg tubes 100 in this embodiment. The second location slot 812 fits the end side of the bottom footplate 500, the inclined plane of the first location slot 811 fits the curve of the inner side of the front leg tubes 100 in this embodiment. The first plastic element 810 is disposed between the bottom footplate 500 and the front leg tubes 100, besides the first location slot 811 fits to touch the inner side of the front leg tubes 100, the second location slot 812 fits to touch the end side of the bottom footplate.

The two first lock pin 820 are disposed with space between in the right and the left. The first lock pin 820 is a rivet, which passes through the supporting frame which rivets the front leg tubes 100, the first plastic element 810 and the bottom footplate 500.

The top footplate 400 rotates between the two front leg tubes 100, the connecting device to connect the top footplate 400 and the front leg tubes 100 includes a second plastic element 910 and a second lock pin 920. The second plastic element 910 is cone shaped with a bigger end side and a smaller end side. The second plastic element 910 is disposed between the top footplate 400 and the front leg tubes 100, and the bigger end side of the second plastic element 910 touches the top footplate 400 while the smaller end side touches the front leg tubes 100.

The second lock pin 920 is a rivet which passes through the supporting frame which rivets the front leg tubes 100, the second plastic element 910 and the top footplate 400.

With the plastic element disposed between the leg tubes and the footplate in the embodiment of the present invention, the first location slot fits the leg tubes and touches the inner side of the leg tube; the second location slot fits the end side of the footplate and touches the end side of the footplate.

The present invention has the advantages below:

1. preventing the footplate rotates relative to the lock pin and the leg tubes, which improves the security and the working life of the step tool;
2. the location slot of the plastic element encases the end side of the footplate and the leg tubes, which posses the wholeness of the step tool and the beautiful appearance;
3. enhancing the connecting strength between the footplate and the leg tubes;
4. preventing the end surface of the footplate scratching the user. As the two lock pins are disposed with space between from up to down, it prevents the footplate rotates, with the high connecting strength between the leg tubes and the footplate. The footplate includes the supporting frame, which have the effects of connecting the component outsides, which is convenient for connecting. The lock pin is a rivet, which is convenient for assemble. The plastic element is cone shaped with the bigger end side touches the footplate and the smaller end side touches the leg tubes, which is convenient for the footplate rotation with reduced friction. At the same time, with the plastic element disposed between the leg tubes and the footplate, the footplate can be designed to new antiskid structure, which makes the step tool easily for use and high reliability.

### The Second Embodiment

The step tool includes two front leg tubes 100, a U-shaped tube 200, two rear leg tubes 300, a top footplate 400, a bottom footplate 500 fixed between the two front leg tubes 100 and a lock catch device 600.

The end of the U-shaped tube 200 fixes to the top of the front leg tubes by a pivot 110, the top of the rear leg tubes 300 rotating joints to the pivot 110, so that the front leg tubes 100 rotation connects to the rear leg tubes. A rail 310 is disposed between the two rear leg tubes 300. (refer to the FIG. 1 and the FIG. 2)

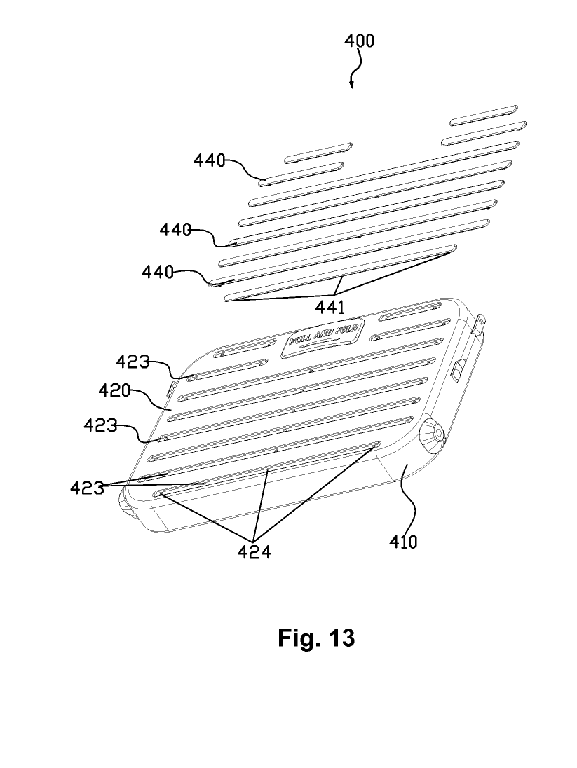

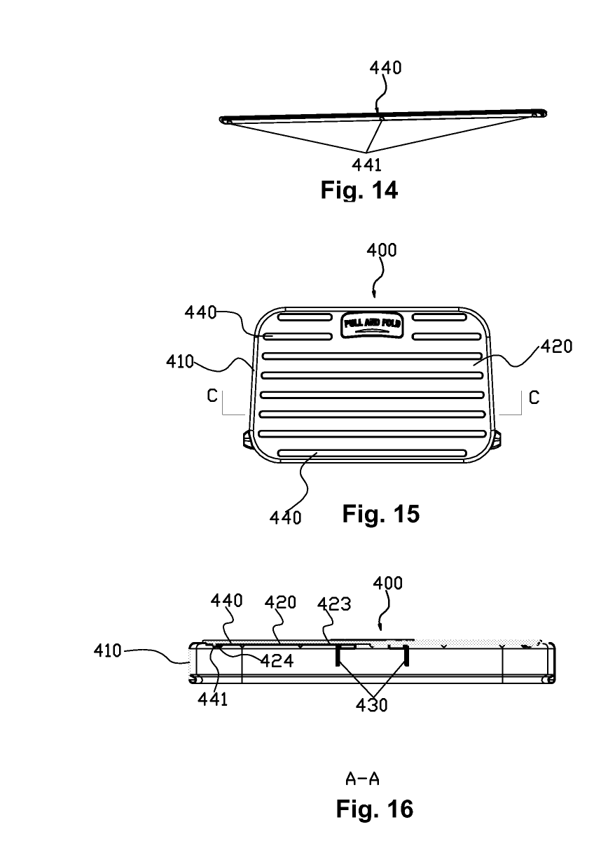

Refer to the FIG. 13, FIG. 14, FIG. 15 and FIG. 16, the top footplate 400 includes a substrate made from aluminum alloy and several antiskid strips 440 made from plastic.

The substrate is disposed with a rectangular figure supporting frame 410, a panel 420 and reinforcing ribs 430, the panel 420 is fixed on the supporting frame 410 and made in one step, the reinforcing ribs 430 joints the supporting frame 410 and supports the panel 420. The top of the panel 420 is disposed with location slots 423 with the same number with the antiskid strip 440. These location slots 423 are disposed uniform spaced in parallel and parallel to the median surface formed by the two axes of the front leg tubes 100. The bottom side of the location slots 423 is disposed with several holes 424 running through the top of the panel 420.

The bottom of the antiskid strip is disposed with several undercuts 441 with the same number with the holes 424. The undercuts 441 are disposed with a fasten section fastening to the bottom side of the antiskid strip, a simply plugged section with conical end and a middle section disposed between the fasten section and the simply plugged section on the bottom side of the antiskid strips 440. The diameter of the middle section is smaller than that of the holes 422; the maximum diameter of the simply plugged section is bigger than that of the holes 422, while the minimum diameter is smaller than the diameter of the holes 422.

These antiskid strips 440 fit the location rabbet 423 one to one correspondence. These antiskid strips 440 are disposed in the corresponding location rabbet 423; the undercuts 441 fit the holes 424 one to one correspondence assembly. The loop step surface of the simply plugged section touches the bottom side of the panel 420.

The thickness of the antiskid rib 440 is greater than the depth of the location slot 423, the top of the antiskid rib 440 is projected from the top of the panel 420.

In another preferred embodiment, the difference from the last preferred embodiment is: the undercut is disposed with a fasten section fastening to the bottom side of the antiskid strip, a simply plugged section with conical end fastening to the simply plugged section, the diameter of the middle section is smaller than that of the hole, the maximum diameter of the simply plugged section is greater than that of the hole.

In another preferred embodiment, the difference from the last preferred embodiment is: the substrate is made from injection molding.

The footplate of the embodiment in the present invention has the advantages below:
1. the antiskid footplate is disposed with antiskid strips, which enhance the antiskid effect of the footplate with high security.
2. the antiskid strip is disposed in the location slot and assembled with the through hole and the undercut, making it more firm and assembled fast.
3. the antiskid strip prevents the abrasion of the antiskid footplate with high reliability. (the antiskid footplate is generally via surface modification, such as dusting and galvanization, surface modification is easy scoring and abrasion), the antiskid strip prevents the bottom of the feet touching the antiskid footplate surface.
4. the antiskid strip is used to enhance the antiskid footplate.
5. the antiskid strip enhances the beauty of the antiskid footplate, making the antiskid footplate full of variety.
6. the location slots parallels to the median surface formed by the two axes of the upright columns with pointed antiskid and high reliability. (as the bottom of the feet is disposed perpendicular to the plane of the footplate, the direction of the antiskid strip is pointed antiskid.)
7. the end of the simply plugged section is cone shaped, which is convenient for assemble and lock catch.
8. the diameter of the middle section is smaller than that of the through hole, the maximum diameter of the simply plugged section is greater than that of the hole, so that the lock catch is firm.
9. the top of the antiskid strip sticks out of the top side of the panel, the antiskid effect is well, which prevents the abrasive of the antiskid footplate.
10. the panel is fixed on the supporting frame, the reinforcing ribs connects to the supporting frame and supports the panel with high the supporting strength, the supporting frame is convenient for connecting components outsides.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

### INDUSTRIAL APPLICABILITY

The present invention is provided with a step tool, which is disposed with lock catch device and the connecting structure between the footplate and the leg tubes of simply usage and high reliability for the top footplate. The top footplate is designed to be antiskid footplate with simple structure, easy using and high industrial applicability.

1. A step tool, includes front leg tubes, rear leg tubes, bottom footplate, top footplate, a connecting device for connecting the footplates and the leg tubes, lock catch device of the top footplate, the front leg tubes joint to the rear leg tubes rotatably, the foreside of the top footplate joints to the front leg tubes rotatably, a rail is fixed on the rear leg tubes, the lock catch device disposed on the top footplate is detachedly connecting to the rail, wherein:
The lock catch device includes:
Two connecting ears, which are disposed on the top footplate with space between in the right and left and stick out of the bottom side of the top footplate;
A rotation axis, which passes through the two connecting ears rotatably;
A lock catch fixed to the rotation axis is disposed with hook rabbet to hook the rail from the outsides towards the inner; and
A torsion spring, which interlinks the rotation axis and generates torque to rotate the rotation axis, the both ends of the torsion spring support against the footplate and the lock catch separately.

2. A step tool according to the claim 1, wherein the top footplate includes a supporting frame to rest on the rail and a panel disposed on the supporting frame; the connecting ears are disposed on the panel and stick out of the bottom surface of the panel; the supporting frame encircles the rotation axis, torsion spring and the lock catch.

3. A step tool according to the claim 2, wherein a stop is disposed on the bottom side of the panel to limit the maximum turned angel of the lock catch, the stop is located between the two connecting ears; the distance between the upper end of the lock catch and the axes of the rotation axis is greater than the distance between the end of the stop and the axes of the rotation axis.

4. A step tool according to the claim 3, wherein two through holes are disposed on the panel with space between in the right and left and pass through from the up to down; an intermediate plate is disposed to fix the two connecting ears, which pass through the through holes from up to down and stick out of the bottom side of the panel, the intermediate plate rests on the top surface of the panel.

5. A step tool according to the claim 3, wherein the lock catch is disposed with a substrate, two convex lugs are disposed on the substrate with space between in the right and left to connect the rotation axis; the top of the convex lug is disposed with a lug to lie against the stop.

6. A step tool according to the claim 5, wherein a plane forms between the two lugs, one end of the torsion spring heads on the bottom side of the panel, the other end heads on the plane.

7. A step tool according to the claim 3, wherein the lock catch is disposed with a substrate, a handle is disposed under the substrate, the handle sticks out to the inner side of the substrate, a hook rabbet is formed between the handle and the substrate, the surface of the handle is disposed with hand held groove.

8. A step tool according to the claim 1, wherein the connecting device between the footplate and the leg tubes includes:
A plastic element, with a first location slot and a second location slot on the both right and left side, the first location slot fits the leg tubes and touches the inner side of the leg tubes, the second location slot fits the end side of the footplate and touches the end side of the footplate; and
Lock pin, which passes through the leg tube and the plastic element and locks to the footplate.

9. A step tool according to the claim 8, wherein the leg tubes are elliptic tubes, the inclined cross section of the first location slot is semi-elliptic which fits the inner side of the leg tube.

10. A step tool according to the claim 8, wherein the end surface of the footplate is smooth surface with the center insides, the inclined cross section of the second location slot is comber and fits the end side of the footplate.

11. A step tool according to the claim 8, wherein the number of the lock pin is two, the two lock pins are disposed with space between from the up to down.

12. A step tool according to the claim 11, wherein:
The footplate includes a supporting frame, a panel and a reinforcing rib, the panel is supporting on the supporting frame, the reinforcing rib joints to the supporting frame and supports the panel;
The lock pin passes through the leg tube and the plastic element and locks to the supporting frame of the footplate.

13. A step tool according to the claim 1, wherein the connecting device connecting the footplate and the leg tubes includes:
a plastic element, which is frustum of a cone with a bigger end side and a smaller end side, the bigger end side touches the footplate, and the smaller end side touches the leg tube; and
lock pin, which passes through the leg tube and the plastic element and locks to the footplate.

14. A step tool according to the claim 13, wherein:
The footplate includes a supporting frame, a panel and a reinforcing rib, the panel is supporting on the supporting frame, the reinforcing rib joints to the supporting frame and supports the panel;
The lock pin passes through the leg tube and the plastic element and locks to the supporting frame of the footplate.

15. A step tool according to the claim 1, wherein the top footplate includes a substrate, the substrate has a panel, the top surface of the substrate is disposed with several location slots, the bottom side of the location slots is disposed with at least a hole running through the top of the panel, every location slot is disposed with an antiskid strip, the bottom of the antiskid strip is disposed with at least an undercut, the undercut and the hole are fastening to each other corresponding.

16. A step tool according to the claim 15, wherein the location slots are disposed uniform spaced in parallel.

17. A step tool according to the claim 16, wherein the location slots parallels to the median surface formed by the two axes of the upright columns.

18. A step tool according to the claim 15, wherein the undercut is disposed with a fasten section fastening to the bottom side of the antiskid strip, a simply plugged section with conical end and a middle section disposed between the fasten section and the simply plugged section, the diameter of the middle section is smaller than that of the hole, the maximum diameter of the simply plugged section is bigger than that of the hole.

19. A step tool according to the claim 15, the undercut is disposed with a fasten section fastening to the bottom side of the antiskid strip, a simply plugged section with conical end fastening to the simply plugged section, the diameter of the middle section is smaller than that of the hole, the maximum diameter of the simply plugged section is greater than that of the hole.

20. A step tool according to the claim 15, wherein the thickness of the antiskid rib is greater than the depth of the location slot, the top of the antiskid rib is projected from the top of the panel.

21. A step tool according to the claim 15, wherein the substrate includes a supporting frame and a reinforcing rib, the panel is fixed on the supporting frame, the reinforcing rib joints to the supporting frame and supports the panel.

22. A step tool according to the claim 9, wherein the number of the lock pin is two, the two lock pins are disposed with space between from the up to down.

23. A step tool according to the claim 10, wherein the number of the lock pin is two, the two lock pins are disposed with space between from the up to down.

24. A step tool according to the claim 22, wherein:
The footplate includes a supporting frame, a panel and a reinforcing rib, the panel is supporting on the supporting frame, the reinforcing rib joints to the supporting frame and supports the panel;
The lock pin passes through the leg tube and the plastic element and locks to the supporting frame of the footplate.

25. A step tool according to the claim 23, wherein:
The footplate includes a supporting frame, a panel and a reinforcing rib, the panel is supporting on the supporting frame, the reinforcing rib joints to the supporting frame and supports the panel;
The lock pin passes through the leg tube and the plastic element and locks to the supporting frame of the footplate.

26. A step tool according to the claim 16, wherein the undercut is disposed with a fasten section fastening to the bottom side of the antiskid strip, a simply plugged section with conical end and a middle section disposed between the fasten section and the simply plugged section, the diameter of the middle section is smaller than that of the hole, the maximum diameter of the simply plugged section is bigger than that of the hole.

27. A step tool according to the claim 17, wherein the undercut is disposed with a fasten section fastening to the bottom side of the antiskid strip, a simply plugged section with conical end and a middle section disposed between the fasten section and the simply plugged section, the diameter of the middle section is smaller than that of the hole, the maximum diameter of the simply plugged section is bigger than that of the hole.

28. A step tool according to the claim 16, the undercut is disposed with a fasten section fastening to the bottom side of the antiskid strip, a simply plugged section with conical end fastening to the simply plugged section, the diameter of the middle section is smaller than that of the hole, the maximum diameter of the simply plugged section is greater than that of the hole.

29. A step tool according to the claim 17, the undercut is disposed with a fasten section fastening to the bottom side of the antiskid strip, a simply plugged section with conical end fastening to the simply plugged section, the diameter of the middle section is smaller than that of the hole, the maximum diameter of the simply plugged section is greater than that of the hole.

30. A step tool according to the claim 16, wherein the thickness of the antiskid rib is greater than the depth of the location slot, the top of the antiskid rib is projected from the top of the panel.

31. A step tool according to the claim 17, wherein the thickness of the antiskid rib is greater than the depth of the location slot, the top of the antiskid rib is projected from the top of the panel.

32. A step tool according to the claim 16, wherein the substrate includes a supporting frame and a reinforcing rib, the panel is fixed on the supporting frame, the reinforcing rib joints to the supporting frame and supports the panel.

33. A step tool according to the claim 17, wherein the substrate includes a supporting frame and a reinforcing rib, the panel is fixed on the supporting frame, the reinforcing rib joints to the supporting frame and supports the panel.
